(19) United States
(12) Patent Application Publication
(10) Pub. No.: US 2008/0278658 A1
(43) Pub. Date: Nov. 13, 2008

(54) FRONT LIGHT UNIT AND FLAT DISPLAY APPARATUS EMPLOYING THE SAME

(75) Inventors: Young-chan Kim, Suwon-si (KR); Jee-hong Min, Seongnam-si (KR); Moon-gyu Lee, Suwon-si (KR); Kyu-min Choe, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/939,773

(22) Filed: Nov. 14, 2007

(30) Foreign Application Priority Data
May 8, 2007 (KR) 10-2007-0044720

(51) Int. Cl. F21V 9/14; G02F 1/1335

(52) U.S. Cl. 349/63; 362/19

(57) ABSTRACT

A front light unit and a flat panel display apparatus including the front light unit are provided. The front light unit includes a light source unit and a light guide plate (LGP) which has a plate shape and which guides light emitted by the light source unit. The LGP has a rear surface through which the guided light exits and a front surface opposing the rear surface. The front light unit also includes a front polarizing plate disposed opposite the front surface of the LGP. The front polarizing plate has a polarizer which transmits only light polarized in one direction. The flat panel display apparatus including the front light unit can provide an improved contrast ratio on a front side thereof.

### CROSS-REFERENCE TO RELATED PATENT APPLICATION

This application claims priority from Korean Patent Application No. 10-2007-0044720, filed on May 8, 2007 in the Korean Intellectual Property Office, the disclosure of which is incorporated by reference in its entirety.

### BACKGROUND OF THE INVENTION

1. Field of the Invention

Apparatuses consistent with the present invention relate to a front light unit and a flat panel display apparatus employing the front light unit, and more particularly, to a front light unit having an improved contrast ratio on a front side thereof and a flat panel display apparatus employing the front light unit.

2. Description of the Related Art

Flat panel displays can be classified into self-emissive displays that emit light to produce images, and non-emissive displays that use light emitted from an external source to produce images. A liquid crystal display (LCD) that is a non-emissive display needs a separate illumination device.

Flat panel displays can also be classified into single-screen display devices that display images on a single side thereof, and dual-screen display devices which display images on two sides thereof. Dual-screen display devices are used in portable devices such as mobile phones, MPEG-1 Audio Layer 3 (MP3) players, Portable Multimedia Players (PMPs), and navigation devices, as well as monitor screens in service centers that allow customers and counselors to see each other. Dual-screen display devices are also used in dual-screen TVs that are installed in waiting rooms at railway stations and airports. Dual-screen LCDs including a single liquid crystal panel and a single light unit are being proposed as dual-screen displays.

FIG. 1 is a side cross-sectional view of a related art dual-screen LCD having a single panel and a single light unit. Referring to FIG. 1, the related art dual-screen LCD includes a front light unit 10 and a semi-transmissive liquid crystal panel 20 disposed behind the front light unit 10. The front light unit 10 includes a light source 11 and a light guide plate (LGP) 13 having a deflection pattern 15. The LGP guides light emitted by the light source 11 toward the semi-transmissive liquid crystal panel 20. The semi-transmissive liquid crystal panel 20 includes a plurality of pixels, each pixel having a reflective region 21 and a transmissive region 23. A portion of light incident on the semi-transmissive liquid crystal panel 20 is reflected from the reflective region 21 and exits through a front surface 13a of the LGP 13 (See image light L_{I1})). The remaining light is transmitted through the transmissive region 23 and exits through a rear surface 20b of the semi-transmissive liquid crystal panel 20 (See image light L_{I2}). The dual-screen LCD having the above-described structure has low manufacturing costs and a slim design due to a reduced number of parts compared to a dual-screen LCD with two panels and one light unit.

However, the related art dual-screen LCD as illustrated in FIG. 1 has a disadvantage of having a low contrast ratio on a front side thereof. Referring to FIG. 1, most of the light emitted by the light source 11 into the LGP 13 is reflected from the front surface 13a of the LGP 13 having the deflection pattern 15 toward the semi-transmissive liquid crystal panel 20. However, a portion of the light emitted by the light source 11 into the LGP 13 is transmitted through the front surface 13a of the LGP 13, reflected from the rear surface 13b of the LGP 13, or reflected from a front surface 20a of the semi-transmissive liquid crystal panel 20, so that noise light L_{N} exits through the front surface 13a of the LGP 13. Because the noise light L_{N} acts as noise with respect to the image light L_{I1} exiting through the front surface 13a of the LGP 13, the contrast ratio on the front side of the dual-screen LCD is degraded.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a front light unit which has an improved contrast ratio on a front side thereof by suppressing noise light from exiting through the front side of the front light unit, and a flat panel display apparatus employing the front light unit.

According to an aspect of the present invention, there is provided a front light unit including a light source unit; and a light guide plate (LGP) which has a plate shape and which guides light emitted by the light source unit. The LGP has a rear surface through which the guided light exits and a front surface disposed opposite the rear surface.

The front light unit also has a front polarizing plate disposed opposite the front surface of the LGP. The front polarizing plate has a polarizer that transmits only light polarized in one direction.

According to another aspect of the present invention, there is provided a flat panel display apparatus including a front light unit which has a light source unit, and an LGP which has a plate shape and which guides light emitted by the light source unit. The LGP has a rear surface through which the guided light exits and a front surface disposed opposite the rear surface. The front light unit also has a front polarizing plate disposed opposite the front surface of the LGP. The front polarizing plate has a polarizer that transmits only light polarized in one direction. The flat panel display also has an image panel disposed opposite the rear surface of the LGP. The image panel produces an image using light irradiated from the front light unit and reflects at least a portion of image light toward the front light unit. Image light used to form an image on a reflective side of the image panel by being reflected by the image panel toward the front light unit is polarized in one direction, and the polarizer has a polarization direction parallel to the polarization direction of the image light reflected from the reflective side of the image panel.

### BRIEF DESCRIPTION OF THE DRAWINGS

The above and other aspects of the present invention will become more apparent by describing in detail exemplary embodiments thereof with reference to the attached drawings in which:

FIG. 1 is a side cross-sectional view of a related art dual-screen LCD having a single panel and a single light unit;

FIG. 2 is a perspective view of a flat panel display apparatus according to an exemplary embodiment of the present invention;

FIG. 3 is a top view of a light source unit in the flat panel display apparatus of FIG. 2, according to an exemplary embodiment of the present invention;

FIG. 4 is a side cross-sectional view of the flat panel display apparatus of FIG. 2, according to an exemplary embodiment of the present invention;

FIG. 5 is a perspective view of a flat panel display apparatus according to another exemplary embodiment of the present invention;

FIG. 6 illustrates a deflection pattern of a light guide plate (LGP) in the flat panel display apparatus of FIG. 5, according to an exemplary embodiment of the present invention;

FIG. 7 is a perspective view of a flat panel display apparatus according to another exemplary embodiment of the present invention; and

FIG. 8 is a perspective view of a flat panel display apparatus according to another exemplary embodiment of the present invention.

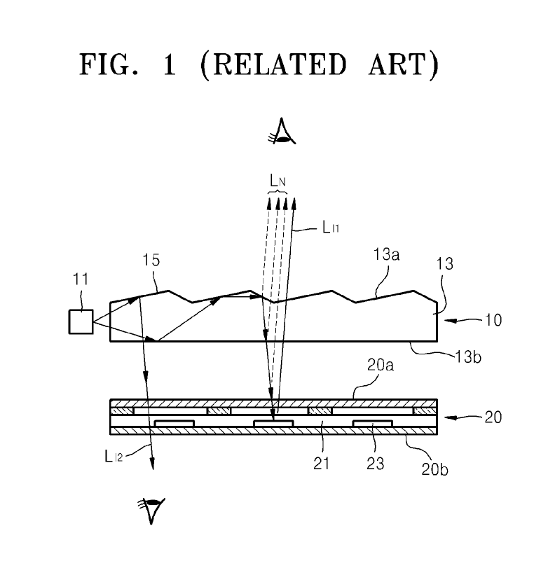

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the sizes and dimensions of elements are exaggerated for better visualization and clarity. Like reference numerals in the drawings denote like elements, and thus their description will be omitted.

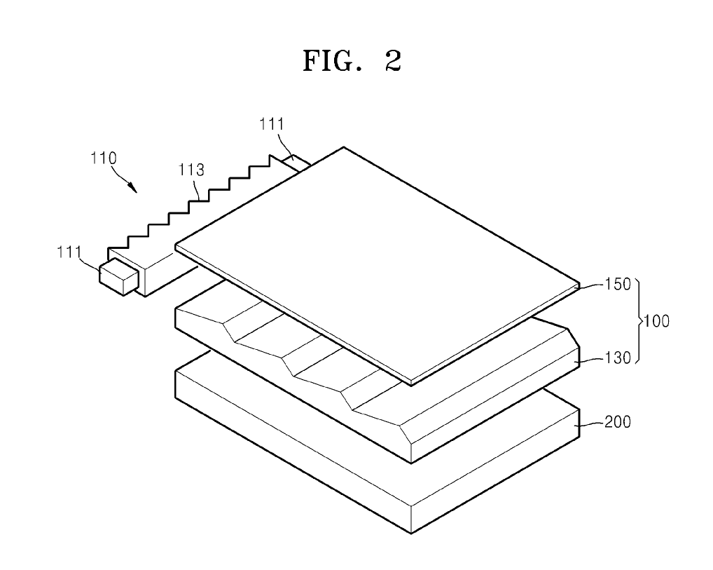

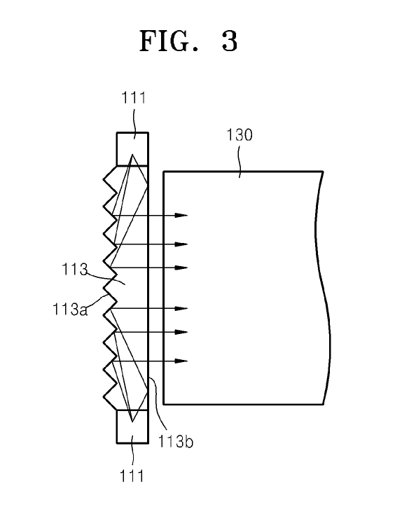

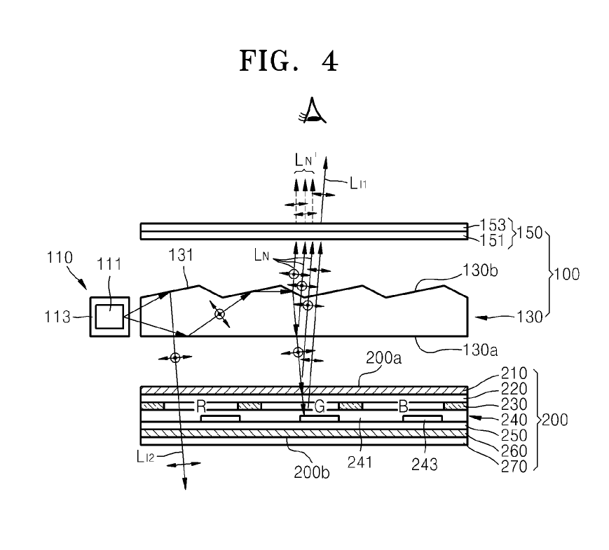

FIGS. 2 through 4 illustrate a front light unit 100 and a flat panel display apparatus including the same according to exemplary embodiments of the present invention. FIG. 2 is a perspective view of a flat panel display apparatus according to an exemplary embodiment of the present invention, FIG. 3 is a top view of a light source unit 110 in the flat panel display apparatus of FIG. 2, and FIG. 4 is a side cross-sectional view of the flat panel display apparatus of FIG. 2.

Referring to FIGS. 2 through 4, the flat panel display apparatus according to the present exemplary embodiment is a dual-screen display including the front light unit 100 and a semi-transmissive image panel 200.

The front light unit 100 is disposed above an outer surface 200a, i.e., a front surface of a reflective side of the semi-transmissive image panel 200, and supplies light to the front surface of the semi-transmissive image panel 200. The front light unit 100 includes a light source unit 110, an LGP 130 which converts light emitted by the light source unit 110 to surface light, and a front polarizing plate 150 disposed above a front surface 130b of the LGP 130.

The light source unit 110 is disposed along a sidewall of the LGP 130 and provides light to the LGP 130. In the present exemplary embodiment, the light source unit 110 includes two point light sources 111 and an auxiliary light-guiding element 113, which guides light from the point light sources 111 toward the sidewall of the LGP 130.

The point light sources 111 may be light emitting diodes (LEDs) and are disposed on either side of the auxiliary light-guiding element 113. The auxiliary light-guiding element 113 is formed of a transparent material having a refractive index greater than 1, such as Polymethylmethacrylate (PMMA) or Polycarbonate (PC), and has a prism pattern 113a on one side thereof. However, the present invention is not limited thereto, and the auxiliary light-guiding element 113 may have other various shapes on one side thereof instead of the prism pattern 113a. The prism pattern 113a reflects light incident on the auxiliary light-guiding element 113 toward the LGP 130. A light exit surface 113b is located adjacent to the sidewall of the LGP 130, facing the side of the auxiliary light-guiding element 113 which incorporates the prism pattern 113a. Light emitted by the point light sources 111 is converted to linear light by the auxiliary light-guiding element 113 before being incident on the LGP 130.

The LGP 130 guides light from the light source unit 110 to illuminate the front surface of the semi-transmissive image panel 200. The LGP 130 has a plate shape including a rear surface 130a through which the guided light exits and a front surface 130b opposing the rear surface 130a. The LGP 130 is formed of a transparent material having a refractive index greater than 1, such as PMMA or PC, and has a deflection pattern 131 on the front surface 130b. The deflection pattern 131 deflects light incident on the LGP 130 toward the rear surface 130a of the LGP 130. Since various shapes of the deflection pattern 131 are well known to those skilled in the art, a detailed description thereof will not be given. The rear surface 130a of the LGP 130 serves both as a light exit surface through which the guided light exits, and as a light incident surface on which light reflected from the semi-transmissive image panel 200 is incident.

The front polarizing plate 150 includes a polarizer 151 which transmits only light polarized in one direction. For example, the polarizer 151 may be an iodine-based polarizing film obtained by stretching a transparent polyvinyl alcohol (PVA) film and aligning iodine with the PVA molecules in the stretching direction, a wire grid polarizer consisting of a grid of a plurality of parallel metal wires, or other various polarizers. The polarizer 151 transmits light that is polarized parallel to the polarization direction of image light L_{I1} exiting through a reflective side of the semi-transmissive image panel 200 while blocking the remaining light. Thus, it is possible to reduce noise light L_{N} that is generated by the semi-transmissive image panel 200 in a front surface direction thereof. The front surface direction refers to the direction in which images are displayed when formed on the reflective side of the semi-transmissive image panel 200.

To suppress reflection of external light, the front polarizing plate 150 further includes a first anti-reflective layer 153. The first anti-reflective layer 153 may be formed on an outer surface of the polarizer 151 on which external light is incident using a deposition or coating technique. By suppressing reflection of external light in this way, a contrast ratio on a front side of the flat panel display apparatus according to the current exemplary embodiment of the present invention can be further improved.

The semi-transmissive image panel 200 is configured to produce images using light illuminated by the LGP 130. For example, the semi-transmissive image panel 200 may be a semi-transmissive liquid crystal panel having transmissive regions 241 which transmit incident light, and reflective regions 243 which reflect incident light. A transmissive region 241 and a reflective region 243 are provided for each pixel over the entire semi-transmissive image panel 200. By adopting the semi-transmissive liquid crystal panel, the flat panel display apparatus according to the present exemplary embodiment can display an image on two sides thereof. That is, a portion of light irradiated from the LGP 130 towards the semi-transmissive image panel 200 is transmitted through the transmissive regions 241 to form an image on a transmissive side of the semi-transmissive image panel 200, and a portion of light irradiated from the LGP 130 towards the semi-transmissive image panel 200 is reflected from the reflective regions 243 to form an image on a reflective side of the semi-transmissive image panel 200.

The semi-transmissive image panel 200 includes a first substrate 220, a second substrate 250, and a liquid crystal layer 240 sandwiched between the first and second substrates 220 and 250. The image panel 200 further includes first and second polarizing sheets 210 and 260 respectively attached to outer surfaces of the first and second substrates 220 and 250. The first polarizing sheet 210 may transmit light polarized in a first direction while absorbing light polarized in a direction perpendicular to the first direction. The second polarizing sheet 250 transmits light polarized in a second direction while absorbing light polarized in a direction perpendicular to the second direction. The first and second directions may be the same or different depending on a method of driving a liquid crystal mode. A color filter 230 is disposed on an inner surface of the first substrate 220. The liquid crystal layer 240 is divided into the transmissive regions 241 and the reflective regions 243. A plurality of reflective layers are formed on an inner surface of the second substrate 250 at regular intervals. The semi-transmissive image panel 200 further includes a second anti-reflective layer 270 that is formed on an outer surface 200b of a transmissive side of the semi-transmissive image panel 200, and prevents reflection of external light. Although not shown, the semi-transmissive image panel 200 further includes pixel electrodes and thin film transistors (TFTs) for driving a plurality of pixels. Images may be simultaneously formed using transmitted and reflected light in two operating modes, or independently in either operating mode using a separate transistor.

The front polarizing plate 150 is disposed above the front surface 130b of the LGP 130 to cover a reflective display area of the semi-transmissive image panel 200. Thus, if the reflective regions 243 are formed over the entire display area of the semi-transmissive image panel 200 as in the present exemplary embodiment, the front polarizing plate 150 is disposed to cover the entire reflective side of the semi-transmissive image panel 200. Alternatively, the reflective regions 243 may be disposed only on a portion of the display area of the semi-transmissive image panel 200. In this case, the front polarizing plate 150 may be disposed to cover only the reflective display area of the semi-transmissive image panel 200.

The operation of the front light unit 100 and the flat panel display apparatus including the same according to the present exemplary embodiments will now be described in detail.

Light emitted by the point light sources 111 is incident into both ends of the auxiliary light-guide element 113 and is directed or totally reflected from the light exit surface 113b of the auxiliary light-guide element 113 toward the prism pattern 113a. The light is then reflected by the prism pattern 113a toward the light exit surface 113b of the auxiliary light-guide element 113. In this case, the light reflected by the prism pattern 113a passes through the light exit surface 113b because the reflected light is perpendicular or nearly perpendicular to the light exit surface 113b. The light emitted by the point light sources 111 is converted into linear light as it is guided by the auxiliary light-guide element 113, and is incident on the LGP 130.

Light entering the LGP 130 is directed or totally reflected from a side in which the deflection pattern 131 is not formed toward the deflection pattern 131, and is reflected by the deflection pattern 131 toward the rear surface 130a of the LGP 130. In this case, the light reflected by the deflection pattern 131 passes through the rear surface 130a of the LGP 130 and is incident on the semi-transmissive image panel 200 because the reflected light is perpendicular or nearly perpendicular to the light exit surface 113b of the auxiliary light-guide element 113. Most of the linear light emitted by the light source unit 110 is converted into surface light, which enters the semi-transmissive image panel 200.

As a portion of the light incident on the semi-transmissive image panel 200 is transmitted through the transmissive regions 241, image light L_{I2} exits the transmissive side of the semi-transmissive image panel 200. As the remaining portion of the incident light is reflected from the reflective regions 243, image light L_{I1} exits the reflective side of the semi-transmissive image panel 200.

A portion of the light entering the LGP 130 is not reflected from the front surface 130b of the LGP 130 but is transmitted therethrough. A portion of the light entering the LGP 130 is not transmitted through the rear surface 130a of the LGP 130 but is reflected therefrom. Furthermore, a portion of light emitted from the front light unit 100 towards the semi-transmissive image panel 200 is reflected from the outer surface 200a of the reflective side of the semi-transmissive image panel 200. The reflected light becomes first noise light L_{N} that is different from the image light L_{I1}, that is used to form a normal image on the reflective side after being reflected from the reflective regions 243 of the semi-transmissive image panel 200.

The image light L_{I1} exiting the reflective side of the semi-transmissive image panel 200 is obtained after light passing through the first polarizing sheet 210 into the liquid crystal layer 240 is modulated by the liquid crystal layer 240 according to image information, and passes back through the first polarizing sheet 210. Thus, the image light L_{I1} is polarized parallel to the direction of polarization of the first polarizing sheet 210. On the other hand, because the point light sources 111 such as LEDs typically have unpolarized characteristics, the first noise light L_{N} generated by reflecting unpolarized light is also unpolarized. That is, the first noise light L_{N} has two polarization components parallel and perpendicular to the polarization direction of the image light L_{I1}.

As the image light L_{I1} passes through the front polarizing plate 150, the image light L_{I1} is transmitted through the front polarizing plate 150 because it is polarized parallel to the direction of polarization of the polarizer 151 of the front polarizing plate 150. On the other hand, as the first noise light L_{N} passes through the front polarizing plate 150, only a polarization component of the first noise light L_{N} parallel to the polarization direction of the polarizer 151 is transmitted through the front polarizing plate 150 to generate second noise light L_{N}′, while the other polarization component is blocked. Thus, an observer located in front of the flat panel display apparatus is able to view the image light L_{I1} exiting the reflective side of the semi-transmissive image panel 200 and the second noise light L_{N}′. Although the second noise light L_{N}′ acts as noise with respect to the image light L_{I1}, it has half the intensity of the first noise light L_{N} obtained before passing through the front polarizing plate 150.

Contrast ratio refers to the degree of difference between bright and dark areas of an image. The first and second noise light L_{N} and L_{N}′ are always generated while supplying light from the light source unit 110, regardless of whether an image is formed on the semi-transmissive image panel 200. Thus, because the first and second noise light L_{N} and L_{N}′ are also generated in the dark area, the contrast ratio is degraded. However, because the second noise light L_{N}′ has half the intensity of the first noise light L_{N}, the contrast ratio can be significantly improved after the first noise light L_{N} passes through the front polarizing plate 150, compared to before the first noise light L_{N} passes through the front polarizing plate 150. In one experiment, when a display apparatus without the front polarizing plate 150 was used, luminances of bright and dark areas of an image were 12.5 nit and 3.7 nit, respectively, and thus a contrast ratio of the image was 3.42:1. When a display apparatus with the front polarizing plate 150 was used, luminances of bright and dark areas of an image were 9.5 nit and 1.7 nit, respectively, and thus a contrast ratio of the image was 5.67:1. The experiment shows that the contrast ratio of the display apparatus with the front polarizing plate 150 is improved by about 60%, compared to the contrast ratio of the display apparatus without the front polarizing plate 150.

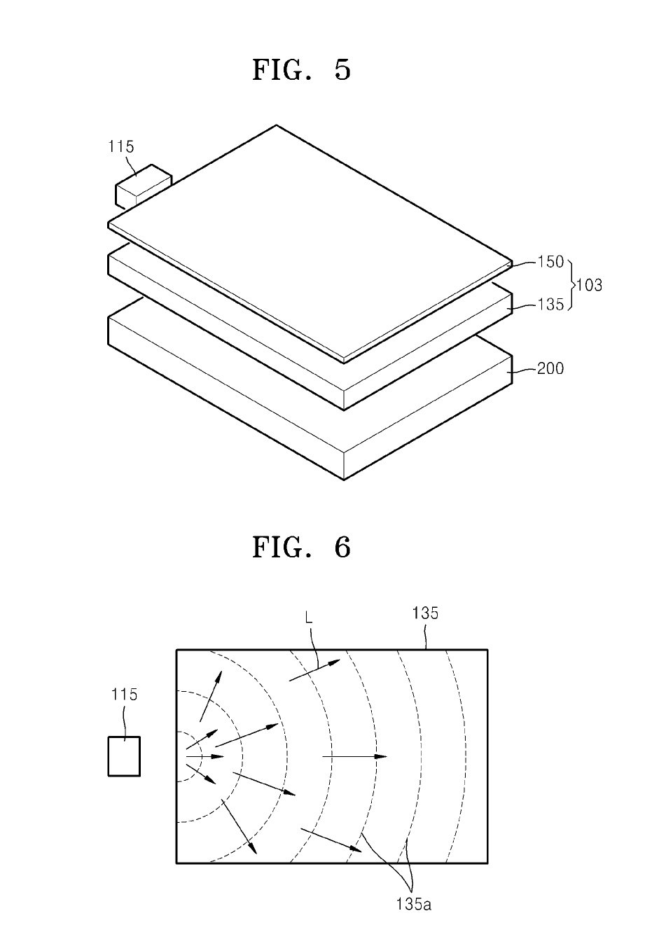

The light source unit 110 is not limited to the structure described in the present exemplary embodiment, and may have other various configurations. A front light unit with a light source unit having another structure will now be described in detail with reference to FIGS. 5 through 8.

FIGS. 5 and 6 illustrate a front light unit 103 and a flat panel display apparatus including the same according to exemplary embodiments of the present invention. FIG. 5 is a perspective view of a flat panel display apparatus according to another exemplary embodiment of the present invention, and FIG. 6 illustrates the deflection pattern of a light guide plate (LGP) 135 in the flat panel display apparatus of FIG. 5.

Referring to FIGS. 5 and 6, the flat panel display apparatus according to the present exemplary embodiment includes the front light unit 103 and an image panel 200. The front light unit 103 includes a light source unit 115, an LGP 135 which converts light from the light source unit 115 into surface light, and a front polarizing plate 150 disposed above a front surface of the LGP 135. Elements in the flat panel display apparatus according to the present exemplary embodiment have substantially the same configurations as those of their counterparts in the flat panel display apparatus according to the embodiment illustrated in FIGS. 2 through 4, except for the light source unit 115 and the LGP 135. Thus, a detailed explanation of the front polarizing plate 150 and the image panel 200 will not be given. That is, the present exemplary embodiment is described mainly with respect to the light source unit 115 and the LGP 135.

The light source unit 115 supplies light L to the LGP 135 and may consist of point light sources such as LEDs.

The LGP 135 guides light L from the light source unit 115 to illuminate the front surface of the image panel 200. The LGP 135 has a deflection pattern 135a on a front surface thereof. The deflection pattern 135a deflects light L totally reflected within the LGP 135 toward the image panel 200. Unlike in the previous exemplary embodiment, the light source unit 115 does not require an auxiliary light-guiding element (113 in FIG. 2). As illustrated in FIG. 6, the deflection pattern 135a may have a curved shape so that the light L from the light source unit 115 can be scattered uniformly within the LGP 135 in a radial direction. Since various shapes of the deflection pattern 131 are well known to those of ordinary skill in the art, a detailed description thereof is omitted.

Although the light source unit 115 and the LGP 135 according to the present exemplary embodiment have slightly different configurations than the light source unit 110 and the LGP 130 in the previous exemplary embodiment, noise light generated on the LGP 135 and the image panel 200 in the front surface direction thereof has unpolarized characteristics similar to the previous exemplary embodiment. That is, the noise light has two polarization components parallel and perpendicular to the polarization direction of image light reflected from a reflective side of the image panel 200. On the other hand, the image light reflected from the reflected side of the image panel 200 has only one polarization component. The front polarizing plate 150 is disposed to transmit light having a polarization component parallel to the polarization direction of the image light reflected from the reflective side of the image panel 200, while intercepting the remaining light. Therefore, all of the image light is transmitted through the front polarizing plate 150 while only a portion of the noise light passes therethrough, thus significantly improving a contrast ratio on a front side of the flat panel display apparatus.

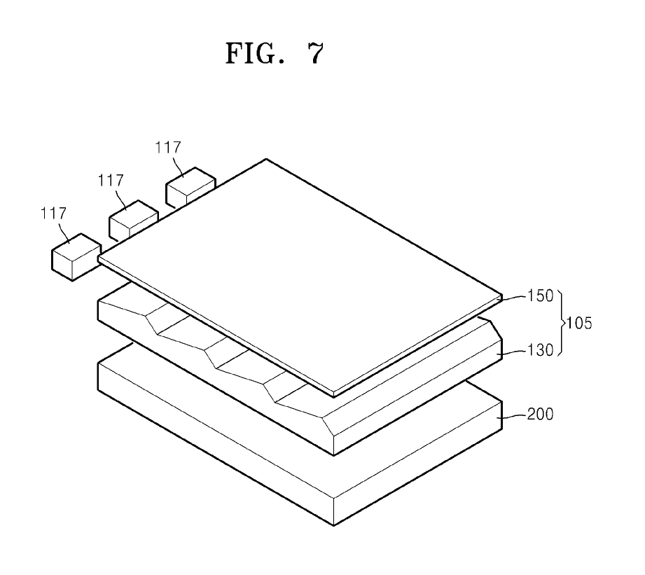

FIG. 7 illustrates a front light unit 105 and a flat panel display apparatus including the same according to exemplary embodiments of the present invention.

Referring to FIG. 7, the flat panel display apparatus according to the present exemplary embodiment includes the front light unit 105 and an image panel 200. The front light unit 105 includes a light source unit having a plurality of point light sources 117, an LGP 130 which converts light from the light source unit into surface light, and a front polarizing plate 150 disposed above a front surface of the LGP 130. Elements in the flat panel display apparatus according to the present exemplary embodiment have substantially the same configurations as those of their counterparts in the flat panel display apparatus according to the exemplary embodiment illustrated in FIGS. 2 through 4, except for the light source unit. More specifically, the light source unit in the present exemplary embodiment includes the plurality of point light sources 117 arranged in a line along a sidewall of the LGP 130. This configuration eliminates the need for an auxiliary light-guiding element (113 in FIG. 2) in the light source unit (110 in FIG. 2). Like in the previous exemplary embodiments, noise light generated on the LGP 130 and the image panel 200 in the front surface direction thereof has unpolarized characteristics. Thus, a contrast ratio on a front side of the flat panel display apparatus according to the current exemplary embodiment of the present invention can be significantly improved, due to the operation of the front polarizing sheet 150.

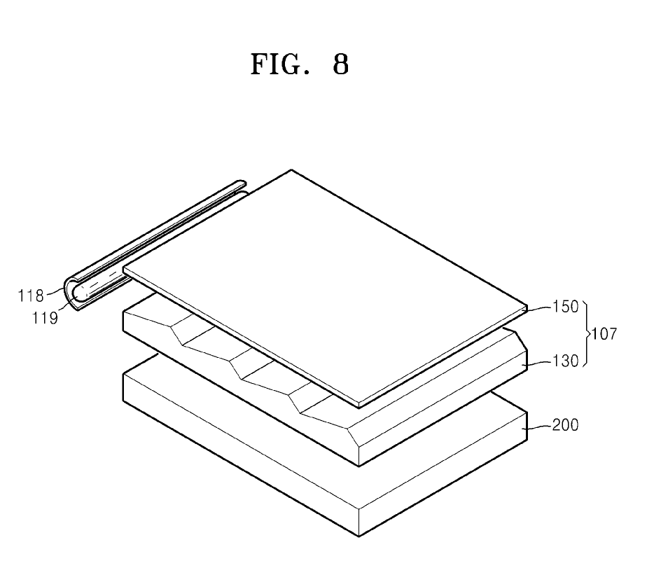

FIG. 8 illustrates a front light unit 107 and a flat panel display apparatus including the same according to exemplary embodiments of the present invention.

Referring to FIG. 8, the flat panel display apparatus according to the present exemplary embodiment includes the front light unit 107 and an image panel 200. The front light unit 107 includes a light source unit having a linear light source 119, an LGP 130 which converts light from the light source unit into surface light, and a front polarizing plate 150 disposed above a front surface of the LGP 130. The linear light source 119 may be a cold cathode fluorescent lamp (CCFL) or an external electrode fluorescent lamp (EEFL). The light source unit in the present exemplary embodiment further includes a reflection plate 118 which condenses light emitted by the linear light source 119 onto the LGP 130. Elements in the flat panel display apparatus according to the present exemplary embodiment have substantially the same configurations as those of their counterparts in the flat panel display apparatus according to the exemplary embodiment illustrated in FIG. 7, except for the light source unit. More specifically, the light source unit in the present exemplary embodiment includes the linear light source 119 instead of point light sources (117 in FIG. 7). Like in the previous exemplary embodiments, noise light generated on the LGP 130 and the image panel 200 in the front surface direction thereof has unpolarized characteristics. Thus, the contrast ratio on a front side of the flat panel display apparatus can be significantly improved due to the operation of the front polarizing sheet 150.

Although in the above description, a semi-transmissive liquid crystal panel is used as an image panel, any type of panel may be used as the image panel, as long as an image can be formed on a front surface of the panel by reflecting a portion of light irradiated from a front light unit. For example, exemplary embodiments of the present invention can be applied to a single-screen display device with a front light unit and a reflective liquid crystal panel.

As described above, a front light unit and flat panel display apparatus according to exemplary embodiments of the present invention are designed to have a front polarizing plate in front of the LGP. Thus, the present invention provides an improved contrast ratio on a front side of the front flat panel display apparatus by effectively reducing noise light generated by an LGP or image panel and exiting through the front of the front light unit.

While a front light unit and a flat panel display apparatus having the same according to the present invention have been particularly shown and described with reference to exemplary embodiments thereof, it will be understood by those of ordinary skill in the art that various changes in form and details may be freely made therein without departing from the spirit and scope of the present invention as defined by the following claims and their legal equivalents.

What is claimed is:

1. A front light unit comprising:
a light source unit;
a light guide plate (LGP) which has a plate shape and which guides light emitted by the light source unit, wherein the LGP comprises a rear surface through which the guided light exits and a front surface disposed opposite the rear surface; and
a front polarizing plate disposed opposite the front surface of the LGP;
wherein the front polarizing plate comprises a polarizer which transmits only light polarized in one direction.

2. The front light unit of claim 1, wherein the front polarizing plate further comprises an anti-reflective layer formed on an outer surface of the polarizer on which external light is incident.

3. The front light unit of claim 1, wherein the light source unit comprises:
at least one point light source; and
an auxiliary light-guiding element disposed along a sidewall of the LGP;
wherein the auxiliary light-guiding element converts light emitted by the at least one point light source into linear light before the light enters the LGP.

4. The front light unit of claim 1, wherein the light source unit comprises at least one point light source disposed along a sidewall of the LGP.

5. The front light unit of claim 1, wherein the light source unit comprises at least one linear light source disposed along a sidewall of the LGP.

6. The front light unit of claim 1, further comprising a deflection pattern on the front surface of the LGP, wherein the deflection pattern deflects light incident on the LGP toward the rear surface of the LGP.

7. A flat panel display apparatus comprising:
a front light unit comprising a light source unit, a light guide plate (LGP) which has a plate shape and which guides light emitted by the light source unit, wherein the LGP comprises a rear surface through which the guided light exits and a front surface disposed opposite the rear surface, and a front polarizing plate disposed opposite the front surface of the LGP, wherein the front polarizing plate comprises a polarizer which transmits only light polarized in one direction; and
an image panel disposed opposite the rear surface of the LGP, wherein the image panel produces an image using light irradiated from the front light unit and reflects at least a portion of image light toward the front light unit; and
image light used to form an image on a reflective side of the image panel by being reflected by the image panel toward the front light unit is polarized in one direction, and the polarizer has a polarization direction parallel to the polarization direction of the image light reflected from the reflective side of the image panel.

8. The apparatus of claim 7, wherein the front polarizing plate further comprises a first anti-reflective layer formed on an outer surface of the polarizer on which external light is incident.

9. The apparatus of claim 8, wherein the image panel further comprises a second anti-reflective layer formed on an outer surface of a transmissive side of the image panel.

10. The apparatus of claim 8, wherein the image panel is a liquid crystal panel comprising polarizing sheets disposed on opposing surfaces of a liquid crystal layer.

11. The apparatus of claim 8, wherein the image panel is a semi-transmissive liquid crystal panel comprising reflective regions which reflect a portion of the light irradiated from the front light unit, and transmissive regions which transmit the remaining portion of the light irradiated from the front light unit.

12. The apparatus of claim 7, wherein the image panel further comprises a first anti-reflective layer formed on an outer surface of a transmissive side of the image panel.

13. The apparatus of claim 7, wherein the light source unit comprises:
at least one point light source; and
an auxiliary light-guiding element disposed along a sidewall of the LGP, wherein the auxiliary light guiding element converts light emitted by the at least one point light source into linear light before the light enters the LGP.

14. The apparatus of claim 7, wherein the light source unit comprises at least one point light source disposed along a sidewall of the LGP.

15. The apparatus of claim 7, wherein the light source unit comprises at least one linear light source disposed along a sidewall of the LGP.

16. The apparatus of claim 7, further comprising a deflection pattern on the front surface of the LGP, wherein the deflection pattern deflects light incident on the LGP toward the rear surface of the LGP.

17. The apparatus of claim 7, wherein the image panel is a liquid crystal panel comprising polarizing sheets disposed on opposing surfaces of a liquid crystal layer.

18. The apparatus of claim 17, wherein the image panel is a semi-transmissive liquid crystal panel comprising reflective regions which reflect a portion of the light irradiated from the front light unit, and transmissive regions which transmit the remaining portion of the light irradiated from the front light unit.

19. The apparatus of claim 18, wherein the reflective region and the transmissive region are provided for each of a plurality of pixels over the entire image panel.
